(19) United States
(12) Patent Application Publication
(10) Pub. No.: US 2025/0060262 A1
(43) Pub. Date: Feb. 20, 2025

(54) OPTICAL TACTILE SENSOR AND SENSOR SYSTEM

(71) Applicant: Panasonic Intellectual Property Management Co., Ltd., Osaka (JP)

(72) Inventors: Hiroaki OKAYAMA, Nara (JP); Yusuke Nakaguchi, Hyogo (JP); Tetsuya Suzuki, Osaka (JP); Ryo Okumura, Osaka (JP); Hideo Onishi, Osaka (JP); Takuya Imaoka, Kanagawa (JP)

(21) Appl. No.: 18/940,093

(22) Filed: Nov. 7, 2024

Related U.S. Application Data
(63) Continuation of application No. PCT/JP2023/009972, filed on Mar. 15, 2023.

(30) Foreign Application Priority Data
May 27, 2022 (JP) 2022-086722

(51) Int. Cl. G01L 1/24; G06T 7/20

(52) U.S. Cl. CPC G01L 1/24; G06T 7/20

(57) ABSTRACT

An optical tactile sensor includes: an elastic member including a contact surface to be brought into contact with an object; a holding member including a window portion and contacting and holding the elastic member, the window portion being transparent; a light source; and a camera that photographs a shape of the contact surface through the window portion, wherein the elastic member includes: a first portion including the contact surface; and a second portion formed integrally with the first portion and disposed between the first portion and the window portion, the second portion being transparent, and the second portion has a hardness higher than a hardness of the first portion.

### CROSS REFERENCE TO RELATED APPLICATIONS

This is a continuation application of PCT International Application No. PCT/JP2023/009972 filed on Mar. 15, 2023, designating the United States of America, which is based on and claims priority of Japanese Patent Application No. 2022-086722 filed on May 27, 2022. The entire disclosures of the above-identified applications, including the specifications, drawings and claims are incorporated herein by reference in their entirety.

### FIELD

The present disclosure relates to an optical tactile sensor and a sensor system.

### BACKGROUND

Patent Literature (PTL) 1 discloses an optical tactile sensor that can simultaneously measure multiple types of mechanical quantities of force acting on a tactile portion from an object when the object comes into contact with the tactile portion.

### CITATION LIST

### Patent Literature

PTL 1: Japanese Unexamined Patent Application Publication No. 2005-257343

### SUMMARY

### Technical Problem

However, the technology of PTL 1 may result in a decrease in the measurement accuracy of the measured mechanical quantities.

Therefore, an object of the present disclosure is to provide an optical tactile sensor that can suppress a decrease in measurement accuracy.

### Solution to Problem

An optical tactile sensor according to one aspect of the present disclosure includes: an elastic member including a contact surface to be brought into contact with an object; a holding member including a window portion and contacting and holding the elastic member, the window portion being transparent; a light source; and a camera that photographs a shape of the contact surface through the window portion, wherein the elastic member includes: a first portion including the contact surface; and a second portion formed integrally with the first portion and disposed between the first portion and the window portion, the second portion being transparent, and the second portion has a hardness higher than a hardness of the first portion.

In addition, an optical tactile sensor according to one aspect of the present disclosure includes: an elastic member including a contact surface to be brought into contact with an object; a holding member including a window portion and contacting and holding the elastic member, the window portion being transparent; a light source; and a camera that photographs a shape of the contact surface through the window portion, wherein the elastic member includes: a first portion including the contact surface; and a second portion formed integrally with the first portion and disposed between the first portion and the window portion, the second portion being transparent, and the second portion is in contact with the window portion over an entire photographing range of the camera.

In addition, a sensor system according to one aspect of the present disclosure includes: the optical tactile sensor described above; and an information processing device that obtains a plurality of images obtained by the camera that photographs the contact surface at different times, calculates a movement of the contact surface using the plurality of images, and calculates at least one of a force that the contact surface is receiving from the object or a change in the force.

### Advantageous Effects

According to the optical tactile sensor and sensor system of the present disclosure, it is possible to prevent a decrease in measurement accuracy.

### BRIEF DESCRIPTION OF DRAWINGS

FIG. 1 is a diagram showing an example of the schematic configuration of a sensor system according to an embodiment.

FIG. 2 is a diagram showing a cross-sectional view of an optical tactile sensor according to an embodiment and an example of a two-dimensional pattern when no load is applied.

FIG. 3 is a diagram showing a cross-sectional view of an optical tactile sensor according to a comparative example and an example of a two-dimensional pattern when a load is applied.

FIG. 4 is a diagram showing a cross-sectional view of an optical tactile sensor according to an embodiment and an example of a two-dimensional pattern when a load is applied.

FIG. 5 is a diagram showing an image including two-dimensional patterns before and after deformation of the tactile portion.

FIG. 6 is a block diagram showing an example of the configuration of an information processing device.

FIG. 7 is a diagram showing an example of a cross-sectional view of an optical tactile sensor according to Variation (1).

FIG. 8 is a diagram showing an example of a cross-sectional view of an optical tactile sensor according to Variation (2).

FIG. 9 is a diagram showing an example of a cross-sectional view of an optical tactile sensor according to Variation (3).

### DESCRIPTION OF EMBODIMENT

### Knowledge Forming Basis of the Present (Underlying Disclosure)

Specifically, PTL 1 discloses an optical tactile sensor including: a tactile portion that includes a convex curved surface at a tip side with which an object can come into direct contact, comprises a light-transmitting elastic body, and has a marker portion disposed on the convex curved surface; a pressing member that is transparent and relatively harder than the light-transmitting elastic body, and is joined in surface contact with the light-transmitting elastic body; and an imaging means that photographs the behavior of the marker portion when the object comes into contact with the convex curved surface from the rear side of the tactile portion through the pressing member.

This optical tactile sensor determines mechanical quantities by analyzing images obtained by an imaging means photographing the behavior of the marker portion. For this reason, in order to maintain a certain level or more of measurement accuracy, it is necessary for the marker portion to be clearly reflected in the image. Here, the marker portion is photographed via a pressing member, which is used to suppress deformation of the surface of the tactile portion on the side of the imaging means, and to make it easier to photograph the marker portion well.

However, when the tactile portion is deformed by an external load, it will deform in an attempt to follow the deformation, and there is a risk that it will peel off from the pressing member. In addition, even if the tactile portion and the pressing member are firmly bonded with an adhesive to prevent peeling due to deformation, the tactile portion itself may tear because it is an elastic body and relatively fragile. Thus, with the prior art, peeling between the tactile portion and the pressing member, or damage to the tactile portion itself, may make it difficult to obtain an image of the marker portion that has been photographed well. This may result in a decrease in the measurement accuracy of the measured mechanical quantities.

Therefore, after extensive research, the inventors have discovered an optical tactile sensor that can suppress a decrease in measurement accuracy.

An optical tactile sensor according to one embodiment of the present disclosure includes: an elastic member including a contact surface to be brought into contact with an object; a holding member including a window portion and contacting and holding the elastic member, the window portion being transparent; a light source; and a camera that photographs a shape of the contact surface through the window portion, wherein the elastic member includes: a first portion including the contact surface; and a second portion formed integrally with the first portion and disposed between the first portion and the window portion, the second portion being transparent, the second portion has a hardness higher than a hardness of the first portion, and the second portion is in contact with the window portion over an entire photographing range of the camera.

According to this, the second portion of the elastic member has a hardness higher than a hardness of the first portion including the contact surface, and is in contact with the window portion over an entire photographing range of the camera. That is, the portion of the elastic member that is in contact with the window portion over an entire photographing range of the camera is less likely to deform than the first portion. For this reason, even if an external load is applied to the contact surface and the first portion deforms, the second portion is less likely to deform. This allows the camera to photograph an image in which the contact surface is clearly reflected through the window portion. This makes it possible to suppress a decrease in the measurement accuracy of the measured mechanical quantities.

In addition, the elastic member may have a hardness that gradually increases from the first portion toward the second portion.

For this reason, when an external load is applied to the contact surface and the first portion is deformed, the amount of deformation can be made smaller toward the second portion. This makes it possible to make the second portion less likely to deform.

In addition, the elastic member may have a hardness that increases in stages from the first portion toward the second portion.

For this reason, when an external load is applied to the contact surface and the first portion is deformed, the amount of deformation can be reduced in stages toward the second portion. This makes it possible to make the second portion less likely to deform.

In addition, the hardness of the elastic member may change in three or more stages.

For this reason, when an external load is applied to the contact surface and the first portion is deformed, the amount of deformation can be reduced in three or more stages toward the second portion. This makes it possible to make the second portion less likely to deform.

In addition, the elastic member may include a first surface and a second surface that are different from each other and adjacent to each other, the holding member may include a first member that contacts the first surface and a second member that contacts the second surface, the first member may include the window portion, and the second portion may include the first surface and the second surface.

According to this, the second portion includes not only a first surface but also a second surface, and is formed so as to cover not only the first surface side but also the second surface side of the first portion. This makes it possible to make the second portion less likely to deform.

In addition, a portion including the second surface of the second portion includes a thickness that decreases as a distance from the first surface increases.

For this reason, the volume of the first portion can be made larger relative to the second portion as the distance from the first surface increases. This makes it possible to deform the contact surface of the elastic member easily and minimize a decrease in measurement sensitivity. That is, by forming the second portion so as to cover the second surface side of the first portion, it is possible to make the second portion less likely to deform and improve the measurement sensitivity at the same time.

In addition, the contact surface and the first surface may be adjacent to each other, the contact surface and the second surface may face each other, and an angle between the first member on which the elastic member is disposed and the second member may be at least 90 degrees and at most 135 degrees.

According to this, since the contact surface and the first surface are adjacent to each other, the camera is disposed, for example, on the first surface side of the elastic member. Thus, the camera is not disposed on the opposite side to the contact surface of the elastic member, but is disposed to the side of the elastic member when the elastic member is viewed from the normal direction of the contact surface, so that it is possible to reduce the thickness of the optical tactile sensor in the normal direction to the contact surface.

In addition, a Shore A hardness of a remaining portion of the elastic member excluding the second portion may be at least 10 degrees and at most 30 degrees, and a Shore A hardness of the second portion may be at least 10 degrees higher than the Shore A hardness of the remaining portion.

This makes it possible to realize the remaining portion excluding the second portion for improving measurement sensitivity and the second portion for improving measurement accuracy.

In addition, the Shore A hardness of the second portion may be at least 20 degrees higher than the Shore A hardness of the remaining portion.

This makes it possible to realize a second portion that is less likely to deform for improving measurement accuracy.

In addition, a ratio of a thickness of a remaining portion excluding the second portion of the elastic member to a thickness of the second portion on a straight line connecting a center of the contact surface and a center of the window portion may be at least 2 and at most 9.

This makes it possible to realize the remaining portion excluding the second portion for improving measurement sensitivity and the second portion for improving measurement accuracy.

In addition, an entirety of the holding member may be made of a transparent material.

For this reason, it is possible for the holding member to comprise a single type of material, and to be easily achieved.

In addition, the holding member may include an opening, and the window portion may be a transparent plate-like member that covers the opening.

A sensor system according to one aspect of the present disclosure includes: the optical tactile sensor described above; and an information processing device that obtains a plurality of images obtained by the camera that photographs the contact surface at different times, calculates a movement of the contact surface using the plurality of images, and calculates at least one of a force that the contact surface is receiving from the object or a change in the force.

For this reason, it is possible to identify the shape of an object pressed against the contact surface and estimate what the object is.

It should be noted that each of the embodiments described below shows comprehensive or specific examples. The numerical values, shapes, components, arrangement positions and connection forms of the components, steps, order of steps, and the like shown in the following embodiments are examples, and are not intended to limit the present invention. In addition, among the components in the following embodiments, the components not described in the independent claims are described as arbitrary components.

In addition, each figure is a schematic diagram and is not necessarily an exact illustration. In addition, in each figure, the same components are denoted by the same reference numerals.

Hereinafter, an embodiment is described in detail with reference to the drawings.

### Embodiment

### 1. Configuration

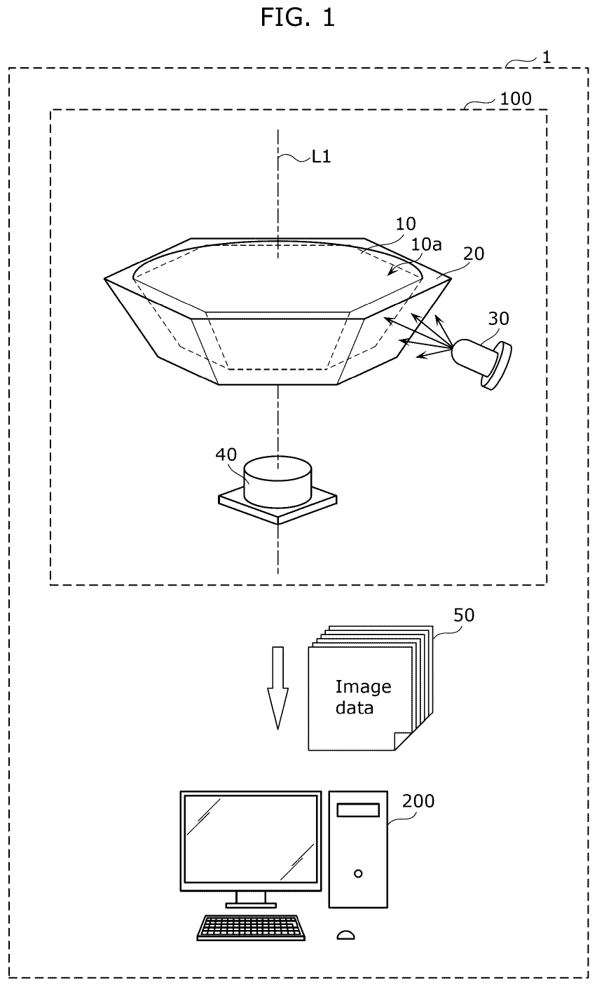

FIG. 1 is a diagram showing an example of the schematic configuration of a sensor system according to an embodiment.

Sensor system 1 includes optical tactile sensor 100 and information processing device 200. It should be noted that in FIG. 1, the side of optical tactile sensor 100 on which contact surface 10a is located is referred to as the front side, and the opposite side is referred to as the rear side.

When an object is brought into contact with contact surface 10a on the front side of elastic member 10, optical tactile sensor 100 photographs the shape of deformed contact surface 10a with camera 40 disposed on the rear side of elastic member 10 while light from light source 30 is irradiated from the rear side. Accordingly, image data 50 that indicates an image for detecting the magnitude of a force that contact surface 10a is receiving from the object and the direction of the force is obtained. Information processing device 200 performs a predetermined image analysis on image data 50 obtained by optical tactile sensor 100 to calculate the magnitude of a force that contact surface 10a is receiving from the object and the direction of the force.

### [1-1. Optical Tactile Sensor]

The specific configuration of optical tactile sensor 100 will be described with reference to FIG. 1 to FIG. 6.

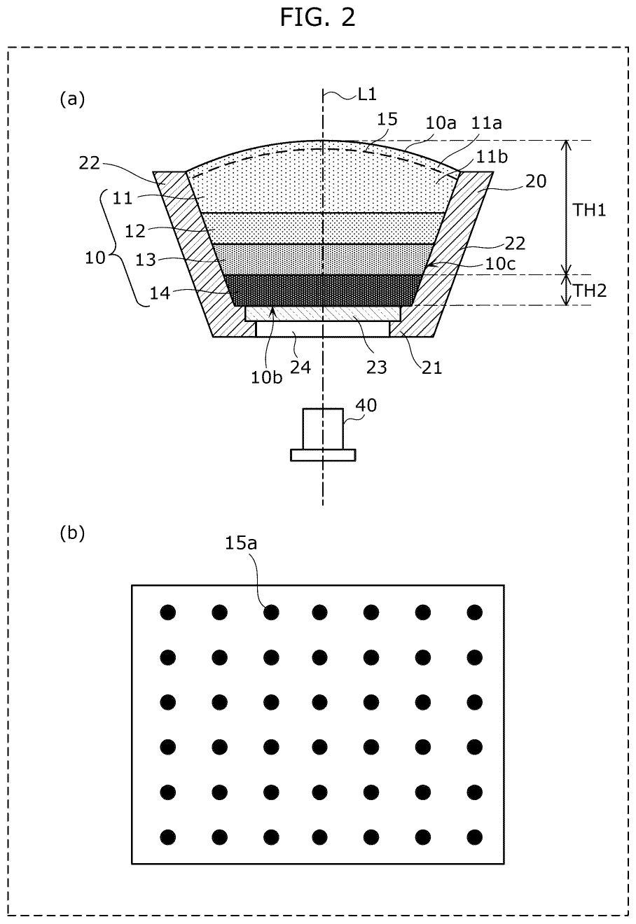

FIG. 2 is a diagram showing a cross-sectional view of an optical tactile sensor according to an embodiment and an example of a two-dimensional pattern when no load is applied. (a) in FIG. 2 is a cross-sectional view of optical tactile sensor 100 taken along a plane passing through optical axis L1 of camera 40. (b) in FIG. 2 is a diagram showing two-dimensional pattern 15 as seen through window portion 23 of holding member 20 in the state of (a) in FIG. 2 (i.e., in the state where no load is applied by an object).

Optical tactile sensor 100 includes elastic member 10, holding member 20, light source 30, and camera 40.

Elastic member 10 includes contact surface 10a to be brought into contact with object 2. Contact surface 10a is, for example, an outwardly convex curved surface. The curved surface may be part of a sphere, part of an ellipsoid or paraboloid, or part of the side surface of a cylinder. The curved surface is not limited to a curved surface with a constant curvature, as long as it is an outwardly convex curved surface. Elastic member 10 is transparent in a portion behind first layer 11a which includes contact surface 10a. For this reason, when elastic member 10 is viewed from behind, first layer 11a can be seen. In addition, the portion of elastic member 10, which includes contact surface 10a, comprises an elastic body.

### [1-1-1. Elastic Member]

Specifically, elastic member 10 includes top layer 11, first intermediate layer 12, second intermediate layer 13, and bottom layer 14. Top layer 11, first intermediate layer 12, second intermediate layer 13, and bottom layer 14 are each in a flat plate-like shape and are laminated in the front-to-rear direction. Elastic member 10 is an elastic body. As shown in (a) in FIG. 2, the cross-sectional shape of elastic member 10 is a substantially isosceles trapezoid with the base on the rear surface side is shorter than the base on the front surface side. Elastic member 10 includes contact surface 10a on the front side, rear surface 10b on the rear side, and side surface 10c on the lateral side. Contact surface 10a and side surface 10c are different surfaces of elastic member 10 from each other and are adjacent to each other. Rear surface 10b and side surface 10c are different surfaces of elastic member 10 from each other and are adjacent to each other. Contact surface 10a and rear surface 10b are different surfaces of elastic member 10 from each other and face each other in the front-rear direction. In the present embodiment, rear surface 10b is an example of a first surface, and side surface 10c is an example of a second surface.

Top layer 11 includes contact surface 10a. Top layer 11 includes first layer 11a which is a part of top layer 11. First layer 11a is an elastic body including contact surface 10a. It should be noted that top layer 11 is an example of a first portion of elastic member 10.

First layer 11a includes contact surface 10a on the front side. First layer 11a has a substantially constant thickness at any position. First layer 11a may be a scattering body. In addition, first layer 11a may comprise an opaque material. In addition, first layer 11a may be a scattering body and comprise an opaque material. First layer 11a may comprise a material colored in a color that can reflect light. The color may be white, a color other than white, such as red, blue, yellow, green, or a color obtained by mixing two or more of these colors. In addition, first layer 11a may comprise a material having a light-shielding property or a material colored to have a light-shielding property. First layer 11a comprises, for example, a silicone resin, a urethane resin, or the like.

It should be noted that first layer 11a may be configured to have a light-shielding property by, for example, a silicone resin, urethane resin, or other base material containing particles for reflecting light (e.g., silver paste) such that the particles are arranged in a two-dimensional manner with no gaps between them. In addition, first layer 11a may be configured to have a light-shielding property by, for example, a silicone resin, urethane resin, or other base material containing particles for absorbing light (e.g., carbon particles (graphene)) such that the particles are arranged in a two-dimensional manner with no gaps between them. The latter, first layer 11a may have a two-layer structure further including a layer containing particles (titanium oxide) for scattering light.

Second layer 11b is a transparent elastic body that contacts the rear surface of first layer 11a. When viewed from the front, the central portion of second layer 11b is thicker than the surrounding portions thereof. Specifically, the front surface on the front side (first layer 11a side) of second layer 11b is raised so that the central portion protrudes forward more than the surrounding portions, and the rear surface on the rear side of second layer 11b is flat. Second layer 11b comprises, for example, silicone resin, urethane resin, or the like.

In addition, first layer 11a may have the same hardness as second layer 11b, or may have a hardness higher than that of second layer 11b. When the hardness of first layer 11a and the hardness of second layer 11b differs, the hardness of top layer 11 is represented by the hardness of second layer 11b. This is because the volume of second layer 11b is larger than the volume of first layer 11a; first layer 11a is a thin layer; and the hardness of second layer 11b is more dominant.

First intermediate layer 12 is a transparent elastic body that contacts the rear of top layer 11. First intermediate layer 12 is formed so as to have a higher hardness than that of top layer 11. It should be noted that when the hardnesses of first layer 11a and second layer 11b that form top layer 11 are different from each other, first intermediate layer 12 is formed so as to have a higher hardness than that of second layer 11b that is represented by the hardness of top layer 11. First intermediate layer 12 comprises, for example, a silicone resin, a urethane resin, or the like.

Second intermediate layer 13 is a transparent elastic body that contacts the rear of first intermediate layer 12. Second intermediate layer 13 is formed so as to have a higher hardness than that of first intermediate layer 12. Second intermediate layer 13 comprises, for example, a silicone resin, a urethane resin, or the like.

Bottom layer 14 is a transparent elastic body that contacts the rear of second intermediate layer 13. Bottom layer 14 is formed so as to have a higher hardness than that of second intermediate layer 13. The surface of bottom layer 14 on the rear side contacts the entire front surface of window portion 23 (described later) of holding member 20. It should be noted that bottom layer 14 only needs to contact over an entire photographing range of camera 40 in window portion 23, and does not have to contact the entire front surface of window portion 23. The photographing range of camera 40 is a partial area of the front surface of window portion 23. Bottom layer 14 comprises, for example, silicone resin, urethane resin, or the like. It should be noted that bottom layer 14 is an example of the second portion of elastic member 10.

Thus, top layer 11, first intermediate layer 12, second intermediate layer 13, and bottom layer 14 have different hardnesses from one a remaining, with top layer 11 having the lowest hardness, followed by first intermediate layer 12, second intermediate layer 13, and bottom layer 14. In addition, second layer 11b of top layer 11, first intermediate layer 12, second intermediate layer 13, and bottom layer 14 each comprise a transparent material.

In other words, elastic member 10 is formed so that the hardness increases in stages from top layer 11 to bottom layer 14. Elastic member 10 is formed so that the hardness changes in four stages: top layer 11, first intermediate layer 12, second intermediate layer 13, and bottom layer 14. It should be noted that elastic member 10 may be formed so that the hardness changes in three or more stages, as in the present embodiment, or so that the hardness changes in two stages.

For example, the Shore A hardness of other portions of elastic member 10 excluding bottom layer 14 (i.e., top layer 11, first intermediate layer 12, and second intermediate layer 13) may be at least 10 degrees and at most 30 degrees. The Shore A hardness of bottom layer 14 may be at least 10 degrees higher than the Shore A hardness of top layer 11, and more preferably at least 20 degrees higher than the Shore A hardness of top layer 11. In addition, the Shore A hardness of other portions of elastic member 10 excluding bottom layer 14 (i.e., top layer 11, first intermediate layer 12, and second intermediate layer 13) may be at least 30 degrees and at most 50 degrees. The Shore A hardness of bottom layer 14 may be at least 5 degrees higher than the Shore A hardness of top layer 11, and more preferably at least 10 degrees higher than the Shore A hardness of top layer 11.

It should be noted that the Shore A hardness of first intermediate layer 12 only needs to be higher than the Shore A hardness of top layer 11 and lower than the Shore A hardness of second intermediate layer 13, and the Shore A hardness of second intermediate layer 13 only needs to be higher than the Shore A hardness of first intermediate layer 12 and lower than the Shore A hardness of bottom layer 14.

In addition, top layer 11, first intermediate layer 12, second intermediate layer 13, and bottom layer 14 each comprise the same material. For example, top layer 11, first intermediate layer 12, second intermediate layer 13, and bottom layer 14 comprise, for example, either a silicone resin or a urethane resin.

The hardnesses of top layer 11, first intermediate layer 12, second intermediate layer 13, and bottom layer 14 may be adjusted by adjusting the amount of hardener mixed per unit volume. Specifically, the greater the amount of hardener, the higher the hardness achieved. That is, the hardness may be adjusted to be highest in bottom layer 14 by mixing the smallest amount of hardener in top layer 11 and mixing increasing amounts of additives in the order of first intermediate layer 12, second intermediate layer 13, and bottom layer 14.

The hardnesses of top layer 11, first intermediate layer 12, second intermediate layer 13, and bottom layer 14 may be adjusted by adjusting the heating time when hardening the resin material before hardening. Specifically, the longer the heating time, the higher the hardness achieved. That is, the hardness may be adjusted to be highest in bottom layer 14 by making the heating time for mixing for top layer 11 the shortest and making the heating times longer in the order of first intermediate layer 12, second intermediate layer 13, and bottom layer 14.

Here, a case where silicone resin is applied to at least one of top layer 11, first intermediate layer 12, second intermediate layer 13, or bottom layer 14 will be described. When silicone resin is used as the material, the base agent and the curing agent are mixed in a ratio of 1:1. When mixing, the mixture is stirred with a stirrer in a space reduced in pressure or evacuated by a vacuum unit to degas the air in the mixed solution. The degassed mixed solution is hardened by heating it, for example, at 150° C. for about 30 minutes. In this way, a hardened silicone resin can be obtained. For example, the mixed solution before the silicone resin hardens can be placed in a mold having the shape of top layer 11, first intermediate layer 12, second intermediate layer 13, and bottom layer 14, to obtain top layer 11, first intermediate layer 12, second intermediate layer 13, and bottom layer 14 that comprise silicone resin.

In addition, the hardness of the silicone resin can be adjusted by adjusting the heating temperature and heating time when it is heated after degassing. If the mixed solution is hardened by maintaining it, for example, at a temperature of 23° C. for 24 hours, a silicone resin having a Shore A hardness of 28 degrees is obtained. In addition, if the mixed solution is hardened by heating it, for example, at a temperature of 100° C. for 3 hours, a silicone resin having a Shore A hardness of 55 degrees is obtained. In this way, a silicone resin adjusted to the desired hardness is obtained.

Next, a case where urethane resin is applied to at least one of top layer 11, first intermediate layer 12, second intermediate layer 13, or bottom layer 14 will be described. When urethane resin is used as the material, the base agent and the hardener are mixed in a ratio of 100:14 to 17. When mixing, the mixture is stirred with a stirrer in a space reduced in pressure or evacuated by a vacuum unit to degas the air in the mixed solution. The degassed mixed solution is hardened by heating it, for example, at 100° C. for about 60 minutes. In this way, hardened urethane resin can be obtained. For example, the mixed solution before the urethane resin hardens can be placed in a mold having the shape of top layer 11, first intermediate layer 12, second intermediate layer 13, and bottom layer 14, to obtain top layer 11, first intermediate layer 12, second intermediate layer 13, and bottom layer 14 that comprise urethane resin.

It should be noted that top layer 11, first intermediate layer 12, second intermediate layer 13, and bottom layer 14 may be formed by hardening and stacking bottom layer 14, second intermediate layer 13, first intermediate layer 12, and top layer 11 in the stated order. That is, after bottom layer 14 is hardened in a mold for forming elastic member 10, a mixed solution for forming second intermediate layer 13 is poured above hardened bottom layer 14 and hardened. Then, a mixed solution for forming first intermediate layer 12 is poured above hardened second intermediate layer 13 and hardened. Then, a mixed solution for forming top layer 11 is poured above hardened first intermediate layer 12 and hardened. Accordingly, elastic member 10 in which top layer 11, first intermediate layer 12, second intermediate layer 13, and bottom layer 14 are adhered together in one piece may be manufactured.

It should be noted that the boundaries of top layer 11, first intermediate layer 12, second intermediate layer 13, and bottom layer 14 may be bonded together with an adhesive. Top layer 11, first intermediate layer 12, second intermediate layer 13, and bottom layer 14 may be bonded together by sandwiching the same type of material as the two adjacent layers between the boundaries of the two layers and heating and hardening the material. The material sandwiched between the boundaries of the two adjacent layers may be applied to a surface of one layer that contacts the other layer, or may be applied to a surface of the other layer that contacts one layer. Accordingly, elastic member 10 in which top layer 11, first intermediate layer 12, second intermediate layer 13, and bottom layer 14 are adhered together in one piece may be manufactured.

In addition, the ratio of the thicknesses of top layer 11, first intermediate layer 12, second intermediate layer 13, and bottom layer 14 of elastic member 10 in the front-to-rear direction may be specified as follows. The ratio of total thickness TH1 of other portions of elastic member 10 excluding bottom layer 14 (i.e., top layer 11, first intermediate layer 12, and second intermediate layer 13) to thickness TH2 of bottom layer 14 on a straight line connecting the center of contact surface 10a and the center of window portion 23 may be at least 2 and at most 9.

In addition, top layer 11 includes two-dimensional pattern 15 disposed along contact surface 10a, as shown in (b) in FIG. 2.

Two-dimensional pattern 15 may be disposed, for example, on the rear surface of first layer 11a. That is, two-dimensional pattern 15 is disposed between first layer 11a and second layer 11b. In addition, it can also be said that two-dimensional pattern 15 is disposed on the surface of second layer 11b on the front side.

Two-dimensional pattern 15 may be a pattern (design) consisting of a plurality of dots 15a arranged two-dimensionally, as shown in (b) in FIG. 2. It should be noted that two-dimensional pattern 15 may be a pattern (design) consisting of grid lines, which are a group of straight lines that extend in two different directions and intersect with each other. In addition, two-dimensional pattern 15 may be a pattern other than a plurality of dots 15a and grid lines, as long as it is a pattern (design) arranged two-dimensionally.

It should be noted that two-dimensional pattern 15 may be a pattern that is regularly arranged two-dimensionally. This can simplify the image processing and reduce the processing load required for the image processing.

Two-dimensional pattern 15 may have a color different from that of first layer 11a, for example, black. Two-dimensional pattern 15 is not limited to black as long as it has a color different from that of first layer 11a. The pattern (design) consisting of a plurality of dots may be a concave or convex portion formed in first layer 11a. The pattern (design) consisting of grid lines may be a groove or a protrusion (rib) formed in first layer 11a. Two-dimensional pattern 15 may have any configuration as long as it can be distinguished from a portion of first layer 11a where two-dimensional pattern 15 is not arranged in the image photographed and obtained by camera 40.

Two-dimensional pattern 15 may be formed, for example, by screen printing a base material colored black onto the rear surface of first layer 11a. It should be noted that two-dimensional pattern 15 may be formed, for example, by screen printing a base material colored black onto the front surface of second layer 11b.

It should be noted that two-dimensional pattern 15 may be disposed inside first layer 11a, that is, between contact surface 10a and the rear surface of first layer 11a, or may be disposed on contact surface 10a. It should be noted that when two-dimensional pattern 15 is disposed on contact surface 10a, first layer 11a may be transparent so that two-dimensional pattern 15 is included in the image photographed and obtained by camera 40, that is, so that two-dimensional pattern 15 is distinguishable in the image.

### [1-1-2. Holding Member]

Holding member 20 includes bottom member 21 that contacts rear surface 10b of elastic member 10, and side member 22 that contacts side surface 10c of elastic member 10. Bottom member 21 is a portion that supports elastic member 10 from behind, and is an example of a first member. Bottom member 21 has opening 24 formed in the center, and includes window portion 23 disposed to cover opening 24. Window portion 23 is a transparent plate-like member. Side member 22 is a portion that supports elastic member 10 from the side, and is an example of a second member. Side member 22 is disposed to extend forward from the periphery of bottom member 21, and is disposed to surround the sides of elastic member 10.

Holding member 20 has a higher rigidity than elastic member 10. Holding member 20 has a hardness that makes it difficult to bend when contact surface 10a is pressed by object 2, for example. The Shore A hardness of holding member 20 may be, for example, 90 degrees or more. The rigidity of holding member 20 may be in such a degree that the bending of holding member 20 caused by contact surface 10a being deformed by receiving a force of a magnitude assumed to be received from object 2 is sufficiently smaller than the amount of depression of elastic member 10 when contact surface 10a is pressed. Here, sufficiently smaller means, for example, 1/50 or less. Holding member 20 and elastic member 10 are fixed in a state of being in close contact with each other. In order to fix holding member 20 and elastic member 10 more firmly, a transparent adhesive may be applied between holding member 20 and elastic member 10. It should be noted that bottom member 21 only needs to be transparent and hold elastic member 10, and may not have a constant thickness. Holding member 20 comprises, for example, polycarbonate, glass, acrylic resin, cycloolefin resin, and the like. It should be noted that in holding member 20, it is only needed that at least the portion of side member 22 where light is irradiated by light source 30 and window portion 23 are transparent, and other portions may be opaque.

### [1-1-3. Light Source]

Light source 30 is disposed on the side of elastic member 10, and emits light diagonally forward from the side of elastic member 10. That is, light source 30 emits light toward first layer 11a via (i) holding member 20 and (ii) at least second layer 11b out of second layer 11b, first intermediate layer 12, second intermediate layer 13, and bottom layer 14.

It should be noted that light source 30 may be disposed behind elastic member 10. In this case, light source 30 may be disposed to the side of camera 40 when viewed along the optical axis of camera 40, for example. It should be noted that light source 30 may be disposed in any position as long as it is disposed outside the angle of view (i.e., the photographing range) of camera 40 and can emit light from behind first layer 11a.

Light source 30 is, for example, a light emitting diode (LED). It should be noted that light source 30 is not limited to an LED, and may be a light bulb, a fluorescent lamp, an organic electro luminescence (EL) lighting, or the like.

Light source 30 may be a light source that emits light of a specific color such as red, green, or blue, or may be a light source that emits light that is a mixture of multiple lights having wavelengths that correspond to multiple colors. It should be noted that light source 30 only needs to be a light source that emits light that can be detected by the image sensor of camera 40.

### [1-1-4. Camera]

Camera 40 is disposed on the side opposite to contact surface 10a of elastic member 10 (i.e., the rear side of elastic member 10) in an orientation facing elastic member 10. The positional relationship between camera 40 and elastic member 10 may be fixed. That is, the distance between camera 40 and elastic member 10 may be a fixed distance. For example, camera 40 and elastic member 10 may be fixed by a support member (not shown). Camera 40 may be disposed so that its optical axis passes through the center of elastic member 10 and is perpendicular to holding member 20 of elastic member 10. It should be noted that camera 40 may be disposed in any position and with any orientation, for example, as long as it is disposed in a position where entire first layer 11a (or two-dimensional pattern 15) of elastic member 10 can be photographed from behind.

Camera 40 photographs first layer 11a (or two-dimensional pattern 15) of elastic member 10 that has received light from light source 30. Camera 40 may, for example, sequentially photographs first layer 11a (or two-dimensional pattern 15). That is, camera 40 is not limited to photograph one still image, but may photograph multiple still images or a video. Therefore, the image photographed and obtained by camera 40 may be multiple still images or a video.

Camera 40 is, for example, a charge coupled device (CCD) camera, a complementary metal oxide semiconductor (CMOS) camera, or the like. Camera 40 may be a color camera or a monochrome camera.

Since holding member 20, second layer 11b, first intermediate layer 12, second intermediate layer 13, and bottom layer 14 comprise transparent materials, the light emitted by light source 30 reaches first layer 11a. The light that reaches first layer 11a is reflected (scattered) at the rear surface of first layer 11a or inside first layer 11a, passes through (i) second layer 11b, first intermediate layer 12, second intermediate layer 13, and bottom layer 14, and (ii) holding member 20, travels backward, and is received by camera 40. Accordingly, camera 40 photographs an image of first layer 11a including two-dimensional pattern 15.

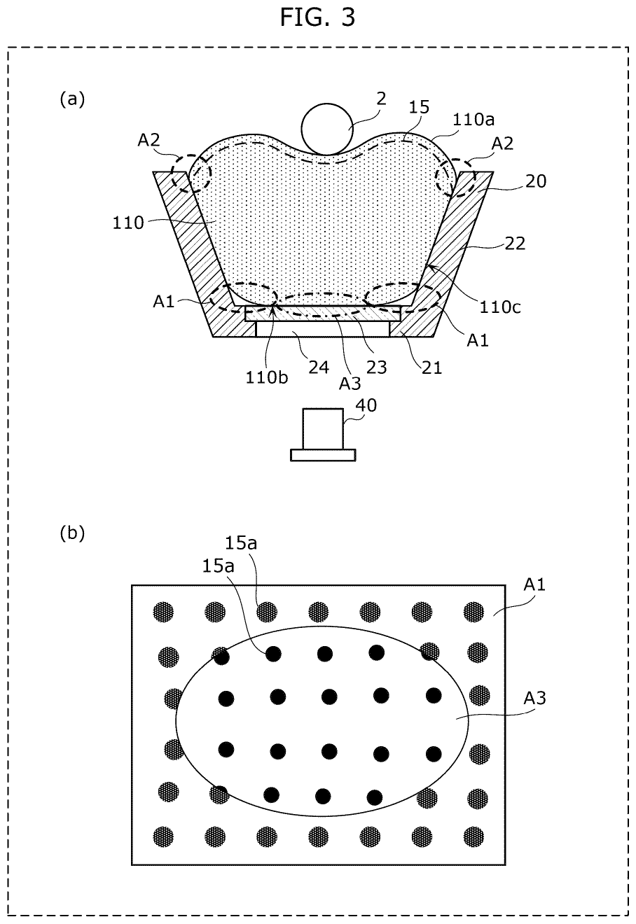

FIG. 3 is a diagram showing a cross-sectional view of an optical tactile sensor according to a comparative example and an example of a two-dimensional pattern when a load is applied. The comparative example is an example of an optical tactile sensor that employs elastic member 110 comprising a material with uniform hardness. The optical tactile sensor of the comparative example has a similar configuration to optical tactile sensor 100 according to the embodiment, except that elastic member 110 is configured with a uniform hardness, so the same configuration is denoted by the same reference numerals and descriptions thereof are omitted.

(a) in FIG. 3 is a cross-sectional view of the optical tactile sensor of the comparative example when a load is applied, taken along a plane passing through the optical axis of camera 40. (b) in FIG. 3 is a diagram showing two-dimensional pattern 15 as seen through window portion 23 of holding member 20 in the state of (a) in FIG. 3 (i.e., the state where a load is applied by object 2).

As shown in (a) in FIG. 3, when a load is applied to contact surface 110a of elastic member 110 from object 2, contact surface 110a is pressed by object 2 and deforms to follow the shape of object 2. In addition, when contact surface 110a of elastic member 110 deforms, the surfaces other than contact surface 110a deform to follow the deformation of contact surface 110a. For example, boundary portion A1 between bottom surface 110b and side surface 110c of elastic member 110 and boundary portion A2 between contact surface 110a and side surface 110c of elastic member 110 may deform into a curved shape, causing elastic member 110 to peel off from holding member 20. In particular, when boundary portion A1 between bottom surface 110b and side surface 110c of elastic member 110 deforms and elastic member 110 peels off from window portion 23 of holding member 20, an air layer will get between elastic member 110 and window portion 23. Accordingly, as shown in (b) in FIG. 3, two-dimensional pattern 15 in boundary portion A1 appears blurred compared to portion A3 where elastic member 110 is in contact with window portion 23. Therefore, it is difficult to obtain an image in which two-dimensional pattern 15 is photographed well.

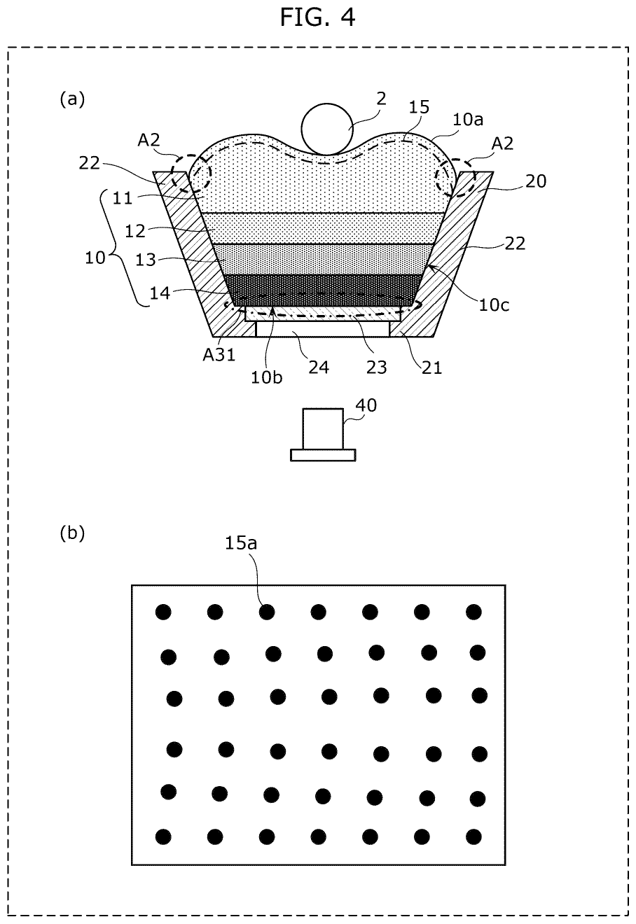

FIG. 4 shows a cross-sectional view of the optical tactile sensor according to the embodiment and an example of a two-dimensional pattern when a load is applied. (a) of FIG. 4 is a cross-sectional view of optical tactile sensor 100 when a load is applied, taken along a plane passing through the optical axis of camera 40. (b) of FIG. 4 is a diagram showing two-dimensional pattern 15 when viewed through window portion 23 of holding member 20 in the state of (a) in FIG. 4 (i.e., when a load is applied by an object).

As shown in (a) in FIG. 4, when a load is applied from object 2 to contact surface 10a of elastic member 10, contact surface 10a is pushed by object 2 and deforms to follow the shape of object 2. However, because the hardness of bottom layer 14 of elastic member 10 is configured to be greater than the hardness of top layer 11, even if contact surface 10a deforms, portion A31 of rear surface 10b in contact with window portion 23 is less likely to deform. This allows elastic member 10 and window portion 23 to maintain contact with each other as shown in (b) in FIG. 4, making it possible to obtain an image in which two-dimensional pattern 15 is photographed well.

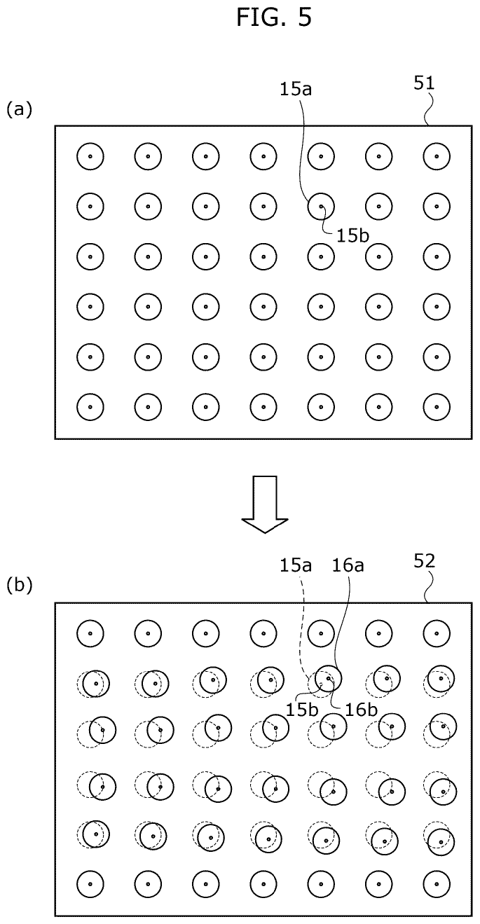

FIG. 5 is a diagram showing an image including a two-dimensional pattern before and after deformation of the tactile portion. It should be noted that in order to easily explain the displacement of a plurality of dots 15a included in two-dimensional pattern 15, FIG. 5 shows a plurality of dots 15a whose outer edge shape is shown as solid circles and centers 15b of the plurality of dots 15a.

When camera 40 photographs an image when contact surface 10a of elastic member 10 is not receiving force from object 2 and is not deformed, image 51 shown in (a) in FIG. 5 is obtained. Image 51 shows two-dimensional pattern 15 that is not deformed.

When camera 40 photographs an image while contact surface 10a of elastic member 10 is being deformed by receiving the force from object 2, image 52 shown in (b) in FIG. 5 is obtained. Image 52 shows a plurality of dots 16a which show displacements of the plurality of dots 15a in undeformed two-dimensional pattern 15. It can be seen that center 16b of the plurality of dots 16a has moved to a position shifted from center 15b of the plurality of dots 15a.

First layer 11a is an elastic body having a uniform thickness and being sufficiently thinner than second layer 11b, so that it deforms into a shape corresponding to the deformation of contact surface 10a. Therefore, image 52 of first layer 11a deformed into a shape corresponding to the deformation of contact surface 10a is obtained. That is, it can also be said that image 52 includes the shape of contact surface 10a. When first layer 11a is deformed, two-dimensional pattern 15 disposed on the rear surface of first layer 11a is also deformed in response to the deformation, so that image 52 obtained when contact surface 10a is deformed by receiving a force from object 2 includes deformed two-dimensional pattern 15 as shown in (b) in FIG. 5. In deformed two-dimensional pattern 15, a plurality of dots are displaced, that is, the positions of a plurality of dots are shifted, compared to non-deformed two-dimensional pattern 15.

It should be noted that FIG. 5 shows an example of two-dimensional pattern 15 including a plurality of dots, but in the case of a two-dimensional pattern including grid lines, the grid lines are deformed in response to the deformation of contact surface 10a. For example, the positions of the intersections of the grid lines are shifted compared to when there is no deformation. In addition, straight grid lines are deformed into curved lines.

Image data 50 including images 51, 52 obtained by camera 40 is output to information processing device 200.

### [1-2. Information Processing Device]

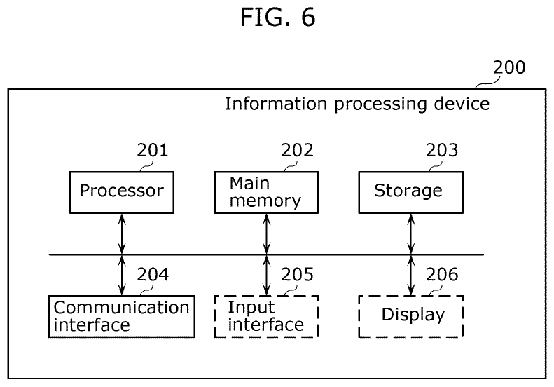

FIG. 6 is a block diagram showing an example of the configuration of an information processing device.

As shown in FIG. 6, information processing device 200 includes, as its hardware configuration, processor 201, main memory 202, storage 203, and communication interface (IF) 204. Information processing device 200 may further include input interface (IF) 205 and display 206.

Processor 201 is a processor that executes programs stored in storage 203 or the like.

Main memory 202 is a volatile storage area that is used for temporarily storing data generated during processing by processor 201, used as a work area used when processor 201 executes a program, and used for temporarily storing data received by communication IF 204.

Storage 203 is a non-volatile storage area that holds various data such as programs. Storage 203 stores data including, for example, various data generated as a result of processing by processor 201, image data 50 received by communication IF 204, and the like. In addition, storage 203 may store in advance image data showing image 51 photographed and obtained when contact surface 10a of elastic member 10 is not receiving force from object 2 and is not deformed. In addition, storage 203 may store feature information showing features of two-dimensional pattern 15 included in image 51. The feature information may be, for example, information showing the positions (two-dimensional coordinates) on image 51 of a plurality of dots 15a included in two-dimensional pattern 15.

Communication IF 204 is a communication interface for receiving image data 50 from camera 40. In addition, communication IF 204 may be a communication interface for transmitting data with an external device such as a smartphone, a tablet, a personal computer (PC), or a server. Communication IF 204 may be an interface for wireless communication, such as a wireless LAN interface or a Bluetooth (registered trademark) interface. Communication IF 204 may be an interface for wired communication, such as a universal serial bus (USB) or a wired LAN interface.

Input IF 205 is an interface for receiving input from a person. Input IF 205 may be a pointing device such as a mouse, a touch pad, a touch panel, or a trackball, or may be a keyboard.

Display 206 is a liquid crystal display, an organic electroluminescence display, or the like.

Information processing device 200 realizes the following functions by processor 201 executing a program.

Information processing device 200 obtains image data 50 output from camera 40, and performs a predetermined image analysis on images 51 and 52 included in obtained image data 50. Information processing device 200 recognizes the shape of two-dimensional pattern 15 included in each of images 51 and 52, and calculates the magnitude of a force that contact surface 10a receives from object 2 and the direction of the force according to the recognized shape of two-dimensional pattern 15. Information processing device 200 compares image 51 stored in storage 203 with each of obtained images 51 and 52, and calculates the magnitude of a force and the direction of the force according to the comparison result. For example, information processing device 200 compares the two-dimensional coordinates of a plurality of dots 15a of two-dimensional pattern 15 included in image 51 stored in storage 203 with the two-dimensional coordinates of a plurality of dots 15a and 16a of two-dimensional pattern 15 included in obtained images 51 and 52.

If the obtained image is image 51, information processing device 200 may determine that no force is being received from object 2 since there is no difference between the two-dimensional coordinates of the plurality of dots 15a in two-dimensional patterns 15 of both images. If the obtained image is image 52, information processing device 200 may determine that there is a difference between the two-dimensional coordinates of the plurality of dots 15a in two-dimensional pattern 15 included in image 51 stored in storage 203 and the two-dimensional coordinates of the plurality of dots 16a in two-dimensional pattern 15 included in obtained image 52. Information processing device 200 identifies this difference, and calculates the magnitude of the force that contact surface 10a is receiving from object 2 and the direction of the force based on the identified difference. That is, information processing device 200 vectorizes the load that contact surface 10a is receiving from object 2.

In addition, information processing device 200 may calculate the movement of contact surface 10a using a plurality of images 51, 52 included in image data 50, and calculate at least one of the force that contact surface 10a is receiving from object 2 or the change in the force.

It should be noted that although information processing device 200 calculates the magnitude of the force that contact surface 10a is receiving from object 2 and the direction of the force based on the difference in the two-dimensional coordinates of a plurality of dots 15a, 16a, the magnitude and direction of the force may be calculated based on a change in the size or shape of the plurality of dots 15a. For example, if the plurality of dots 15a are circular, the magnitude and direction of the force may be calculated based on a change in the size of the circular dots or a change in the circular shape. Here, the size of the circular dot refers to the area, circumference, radius, diameter, or the like of the dot.

The calculated magnitude and direction of the force may be presented on display 206, or may be notified to a pre-registered smartphone, tablet, PC, or the like via communication IF 204.

In addition, information processing device 200 may calculate the shape of the portion of object 2 that is in contact with contact surface 10a, according to the shape of recognized two-dimensional pattern 15. It should be noted that when two-dimensional pattern 15 includes a plurality of dots, the shape of the plurality of dots is the shape of the arrangement of the plurality of dots.

### 2. Effects Etc

Optical tactile sensor 100 according to the present embodiment includes elastic member 10, holding member 20, light source 30, and camera 40. Elastic member 10 includes contact surface 10a to be brought into contact with object 2. Holding member 20 includes transparent window portion 23, and holds elastic member 10 in contact with it. Camera 40 photographs the shape of contact surface 10a through window portion 23. Elastic member 10 includes top layer 11 as a first portion, and bottom layer 14 as a second portion. Top layer 11 includes a contact surface. Bottom layer 14 is formed integrally with top layer 11, and is disposed between top layer 11 and window portion 23. Bottom layer 14 has a hardness higher than that of top layer 11, and is in contact with window portion 23 over an entire photographing range of camera 40.

According to this, bottom layer 14 of elastic member 10 has a higher hardness than that of top layer 11 having contact surface 10a, and is in contact with window portion 23 over an entire photographing range of camera 40. That is, the portion of elastic member 10 that is in contact with window portion 23 over an entire photographing range of camera 40 is less likely to deform than top layer 11. For this reason, even if an external load is applied to contact surface 10a and top layer 11 deforms, bottom layer 14 is less likely to deform. This allows camera 40 to photograph an image in which contact surface 10a is clearly reflected through window portion 23. This makes it possible to suppress a decrease in the measurement accuracy of the measured mechanical quantities.

In addition, in optical tactile sensor 100 according to the present embodiment, elastic member 10 is formed so that the hardness increases in stages from top layer 11 to bottom layer 14. For this reason, when an external load is applied to contact surface 10a and top layer 11 is deformed, the amount of deformation can be reduced in stages toward bottom layer 14. This makes it possible to make bottom layer 14 less likely to deform.

In addition, in optical tactile sensor 100 according to the present embodiment, elastic member 10 is formed so that its hardness changes in three or more stages. For this reason, when an external load is applied to contact surface 10a and top layer 11 is deformed, the amount of deformation can be reduced in three or more stages toward bottom layer 14. This makes it possible to make bottom layer 14 less likely to deform.

In addition, in optical tactile sensor 100 according to the present embodiment, elastic member 10 includes rear surface 10b and side surface 10c that are different from each other and adjacent to each other. Holding member 20 includes window portion 23, and includes bottom member 21 that contacts rear surface 10b, and side member 22 that contacts side surface 10c.

According to this, holding member 20 includes bottom member 21 and side member 22 so as to be formed to cover not only rear surface 10b side of elastic member 10 but also side surface 10c side. This allows holding member 20 to hold elastic member 10 so that it is less likely to deform.

In addition, in optical tactile sensor 100 according to the present embodiment, the Shore A hardness of other portions of elastic member 10 excluding bottom layer 14 is at least 10 degrees and at most 30 degrees. The Shore A hardness of bottom layer 14 is at least 10 higher than that of the remaining portion. This makes it possible to realize the remaining portion excluding bottom layer 14 for improving measurement sensitivity, and bottom layer 14 for improving measurement accuracy.

In addition, in optical tactile sensor 100 according to the present embodiment, the Shore A hardness of bottom layer 14 is at least 20 degrees higher than the remaining portion of elastic member 10 excluding bottom layer 14. This makes it possible to realize bottom layer 14 for improving measurement accuracy that is less likely to deform.

In addition, in optical tactile sensor 100 according to the present embodiment, the ratio of thickness TH1 of other portions of elastic member 10 excluding bottom layer 14 to thickness TH2 of bottom layer 14 on straight line L1 connecting the center of contact surface 10a and the center of window portion 23 is at least 2 and at most 9. This makes it possible to realize the remaining portion excluding bottom layer 14 for improving measurement sensitivity, and bottom layer 14 for improving measurement accuracy.

In addition, in optical tactile sensor 100 according to the present embodiment, an entirety of holding member 20 is made of a transparent material. For this reason, holding member 20 can comprise one type of material, which can be easily realized.

In addition, in optical tactile sensor 100 according to the present embodiment, holding member 20 includes opening 24. Window portion 23 is a transparent plate-like member that covers opening 24. For this reason, even if holding member 20 is an opaque member, it is easy to make the photographing range of camera 40 transparent.

### 3. Variations (1)

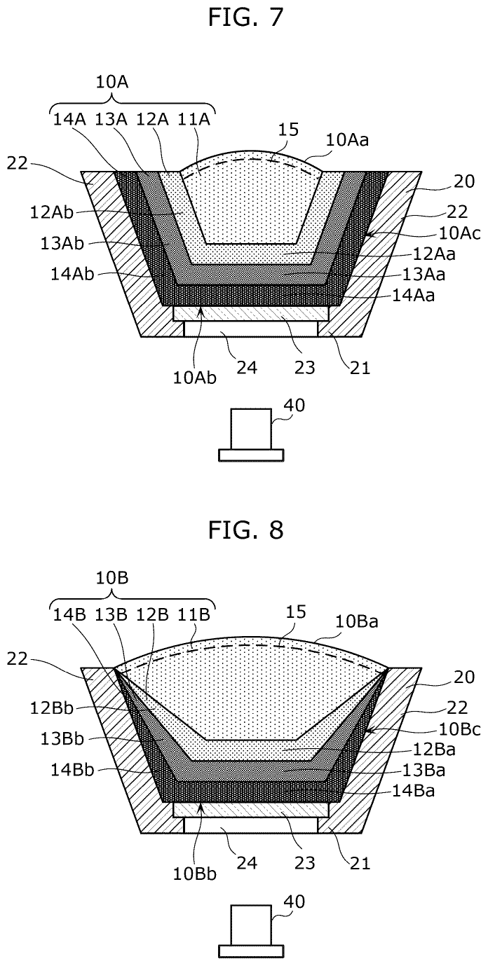

In optical tactile sensor 100 according to the above embodiment, top layer 11, first intermediate layer 12, second intermediate layer 13, and bottom layer 14 are each in a flat plate shape and are stacked in the front-to-rear direction, but the present disclosure is not limited thereto. FIG. 7 is a diagram showing an example of a cross-sectional view of an optical tactile sensor according to Variation (1).

As shown in FIG. 7, the configuration excluding top layer 11A including contact surface 10Aa of elastic member 10A, that is, first intermediate layer 12A, second intermediate layer 13A, and bottom layer 14A, may be in a shape that conforms to the shape of holding member 20. That is, first intermediate layer 12A may include first portion 12Aa that is along bottom member 21 of holding member 20 and second portion 12Ab that is along side member 22. Similarly, second intermediate layer 13A may include first portion 13Aa that is along bottom member 21 of holding member 20 and second portion 13Ab that is along side member 22. Similarly, bottom layer 14A may include first portion 14Aa that is along bottom member 21 of holding member 20 and in contact with bottom member 21, and second portion 14Ab that is along side member 22 and in contact with side member 22. Thus, since bottom layer 14A of elastic member 10A includes first portion 14Aa and second portion 14Ab, bottom layer 14A includes rear surface 10Ab and side surface 10Ac. It should be noted that each of second portions 12Ab, 13Ab, and 14Ab may have a uniform thickness.

According to Variation (1), bottom layer 14A includes not only rear surface 10Ab but also side surface 10Ac, so as to be formed to cover not only the bottom surface side but also the side surface side of top layer 11A. This makes it possible to make bottom layer 14A less likely to deform.

(2)

In elastic member 10A according to the above Variation (1), each of second portions 12Ab, 13Ab, and 14Ab has a uniform thickness, but the present disclosure is not limited thereto. FIG. 8 is a diagram showing an example of a cross-sectional view of an optical tactile sensor according to Variation (2).

As shown in FIG. 8, the configuration excluding top layer 11B including contact surface 10Ba of elastic member 10B, that is, first intermediate layer 12B, second intermediate layer 13B, and bottom layer 14B, may be in a shape that conforms to the shape of holding member 20. That is, first intermediate layer 12B may include first portion 12Ba that is along bottom member 21 of holding member 20 and second portion 12Bb that is along side member 22. Similarly, second intermediate layer 13B may include first portion 13Ba that is along bottom member 21 of holding member 20 and second portion 13Bb that is along side member 22. Similarly, bottom layer 14B may include first portion 14Ba that is along bottom member 21 of holding member 20 and in contact with bottom member 21, and second portion 14Bb that is along side member 22 and in contact with side member 22. Thus, since bottom layer 14B of elastic member 10B includes first portion 14Ba and second portion 14Bb, bottom layer 14B includes rear surface 10Bb and side surface 10Bc. Here, unlike second portions 12Ab, 13Ab, and 14Ab, respective second portions 12Bb, 13Bb, and 14Bb may be configured to become thinner as the distance from rear surface 10Bb increases.

For this reason, the volume of top layer 11B can be made larger relative to first intermediate layer 12B, second intermediate layer 13B, and bottom layer 14B as the distance from rear surface 10Bb increases. This makes it possible to deform contact surface 10Ba of elastic member 10B easily and minimize a decrease in measurement sensitivity. That is, by forming bottom layer 14B to cover top layer 11B on the side surface side, it is possible to make bottom layer 14B less likely to deform and improve the measurement sensitivity at the same time.

(3)

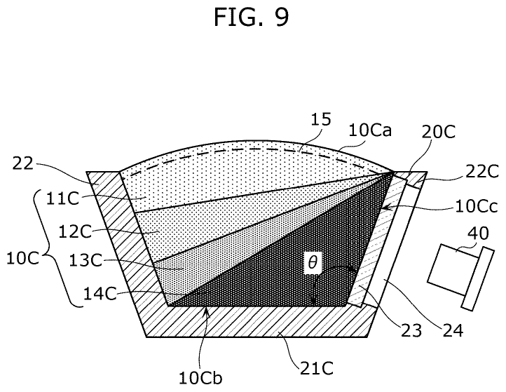

In optical tactile sensor 100 according to the above embodiment, window portion 23 of holding member 20 is disposed at a position in contact with rear surface 10b of elastic member 10, but the present disclosure is not limited thereto. FIG. 9 is a diagram showing an example of a cross-sectional view of an optical tactile sensor according to Variation (3).

As shown in FIG. 9, holding member 20C includes bottom member 21C that supports rear surface 10Cb of elastic member 10C, and side member 22C that supports side surface 10Cc of elastic member 10C. Side member 22C includes opening 24 and window portion 23 that is a transparent plate-like member that covers opening 24. Bottom member 21C and side member 22C are connected so that angle θ formed between bottom member 21C and side member 22C in which window portion 23 is provided is at least 90 degrees and at most 135 degrees. Side member 22C is an example of a first member, and bottom member 21C is an example of a second member.

Elastic member 10C includes top layer 11C, first intermediate layer 12C, second intermediate layer 13C, and bottom layer 14C. Top layer 11C, first intermediate layer 12C, second intermediate layer 13C, and bottom layer 14C are formed so that their boundary surfaces are inclined with respect to bottom member 21C. Bottom layer 14C is formed across window portion 23 and bottom member 21C, and is configured so that the boundary surface with second intermediate layer 13C is inclined with respect to bottom member 21C. Each of top layer 11C, first intermediate layer 12C, second intermediate layer 13C, and bottom layer 14C is configured so that its thickness becomes thinner as it approaches window portion 23. Thus, contact surface 10Ca and side surface 10Cc that contacts side member 22C including window portion 23 are adjacent to each other. In addition, contact surface 10Ca faces rear surface 10Cb.

According to this, since contact surface 10Ca and side surface 10Cc in contact with side member 22C including window portion 23 are adjacent to each other, camera 40 is disposed, for example, on the side surface side of elastic member 10C. Thus, camera 40 is not disposed on the opposite side to contact surface 10Ca of elastic member 10C, but is disposed to the side of elastic member 10C when elastic member 10C is viewed from the normal direction of contact surface 10Ca, so that the thickness of the optical tactile sensor in the normal direction to contact surface 10Ca can be reduced.

(4)

In the above embodiment, an example in which one light source 30 is disposed on the side of elastic member 10 is illustrated, but the present disclosure is not limited thereto, and three or more light sources may be arranged on the side of elastic member 10. The three or more light sources may be arranged, for example, so as to surround elastic member 10 when elastic member 10 is viewed from the front. That is, the three or more light sources may be arranged in positions where the three or more light sources emit light at different angles from one a remaining toward the center of elastic member 10. In addition, the three or more light sources may emit light of different colors from one a remaining, and these colors may correspond to subpixels of the image sensor of camera 40 for each color. For example, the three or more light sources may be three light sources of red, green, and blue, and the image sensor of camera 40 may be a sensor in which each pixel includes red, green, and blue subpixels.

Accordingly, red, green, and blue light from three light sources arranged on the side of elastic member 10 is irradiated onto first layer 11a from three different directions, so that when contact surface 10a of elastic member 10 is pressed and recessed, a shadow is created in the recessed portion with light of each color in each direction. That is, since light is irradiated from three different directions, light blocking can be reduced, and since the light from the three different directions is of different colors, it is possible to distinguish between the light from each direction. Since camera 40 photographs an image including the shadow of the light of each color created by the recession of contact surface 10a, the image obtained by camera 40 includes the shadow. Therefore, information processing device 200 can identify the shape of the object pressed against the contact surface by performing image analysis.

It should be noted that the colors of the three or more light sources do not have to be different colors, and three or more light sources emitting light of the same color may be arranged on the side of elastic member 10. In addition, the number of light sources is not limited to three or more, and two or more light sources may be arranged on the side of elastic member 10. In addition, two or more light sources may be arranged behind elastic member 10.

(5)

In the above embodiment, contact surface 10a is an outwardly convex curved surface, but it is not limited to an outwardly convex curved surface and may be a surface of a remaining shape.

(6)

Although optical tactile sensor 100 according to the above embodiment and its variations is configured to include one camera 40, it may be configured to include a plurality of cameras. Similar to camera 40, the plurality of cameras only need to be arranged behind elastic member 10 so as to photograph an image of first layer 11a of elastic member 10.

(7)

Although optical tactile sensor 100 according to the above embodiment and its variations is configured to include light source 30, it is not necessary to include light source 30. For example, reflected light obtained by natural light, ambient light, or light emitted from a light source disposed outside optical tactile sensor 100 being reflected by first layer 11a may be photographed by camera 40. The optical tactile sensor in this case may include a light guide that guides natural light, ambient light, or light emitted from a light source disposed outside optical tactile sensor 100, to first layer 11a.

While the optical tactile sensor according to one or more aspects of the present disclosure has been described above based on the embodiment, the present disclosure is not limited to this embodiment. Forms obtained by applying various modifications to the present embodiment conceived by a person skilled in the art or forms constructed by arbitrarily combining the components in different embodiments without departing from the spirit of the present disclosure may also be included in the scope of the present disclosure.

### INDUSTRIAL APPLICABILITY

The present disclosure is useful as an optical tactile sensor and the like that can suppress a decrease in measurement accuracy.

1. An optical tactile sensor comprising:
an elastic member including a contact surface to be brought into contact with an object;
a holding member including a window portion and contacting and holding the elastic member, the window portion being transparent;
a light source; and
a camera that photographs a shape of the contact surface through the window portion,
wherein the elastic member includes:
a first portion including the contact surface; and
a second portion formed integrally with the first portion and disposed between the first portion and the window portion, the second portion being transparent, and
the second portion has a hardness higher than a hardness of the first portion.

2. The optical tactile sensor according to claim 1,
wherein the second portion is in contact with the window portion over an entire photographing range of the camera.

3. The optical tactile sensor according to claim 1,
wherein the elastic member has a hardness that gradually increases from the first portion toward the second portion.

4. The optical tactile sensor according to claim 1,
wherein the elastic member has a hardness that increases in stages from the first portion toward the second portion.

5. The optical tactile sensor according to claim 4,
wherein the hardness of the elastic member changes in three or more stages.

6. The optical tactile sensor according to claim 1,
wherein the elastic member includes a first surface and a second surface that are different from each other and adjacent to each other,
the holding member includes a first member that contacts the first surface and a second member that contacts the second surface,
the first member includes the window portion, and
the second portion includes the first surface and the second surface.

7. The optical tactile sensor according to claim 6,
wherein a portion including the second surface of the second portion includes a thickness that decreases as a distance from the first surface increases.

8. The optical tactile sensor according to claim 6,
wherein the contact surface and the first surface are adjacent to each other,
the contact surface and the second surface face each other, and
an angle between the first member on which the elastic member is disposed and the second member is at least 90 degrees and at most 135 degrees.

9. The optical tactile sensor according to claim 1,
wherein a Shore A hardness of a remaining portion of the elastic member excluding the second portion is at least 10 degrees and at most 30 degrees, and
a Shore A hardness of the second portion is at least 10 degrees higher than the Shore A hardness of the remaining portion.

10. The optical tactile sensor according to claim 9,
wherein the Shore A hardness of the second portion is at least 20 degrees higher than the Shore A hardness of the remaining portion.

11. The optical tactile sensor according to claim 1,
wherein a ratio of a thickness of a remaining portion excluding the second portion of the elastic member to a thickness of the second portion on a straight line connecting a center of the contact surface and a center of the window portion is at least 2 and at most 9.

12. The optical tactile sensor according to claim 1,
wherein an entirety of the holding member is made of a transparent material.

13. The optical tactile sensor according to claim 1,
wherein the holding member includes an opening, and
the window portion is a transparent plate-like member that covers the opening.

14. An optical tactile sensor comprising:
an elastic member including a contact surface to be brought into contact with an object;
a holding member including a window portion and contacting and holding the elastic member, the window portion being transparent;
a light source; and
a camera that photographs a shape of the contact surface through the window portion,
wherein the elastic member includes:
a first portion including the contact surface; and
a second portion formed integrally with the first portion and disposed between the first portion and the window portion, the second portion being transparent, and
the second portion is in contact with the window portion over an entire photographing range of the camera.

15. A sensor system comprising:
the optical tactile sensor according to claim 1; and
an information processing device that obtains a plurality of images obtained by the camera that photographs the contact surface at different times, calculates a movement of the contact surface using the plurality of images, and calculates at least one of a force that the contact surface is receiving from the object or a change in the force.

16. A sensor system comprising:
the optical tactile sensor according to claim 14; and
an information processing device that obtains a plurality of images obtained by the camera that photographs the contact surface at different times, calculates a movement of the contact surface using the plurality of images, and calculates at least one of a force that the contact surface is receiving from the object or a change in the force.
